(19) United States
(12) Patent Application Publication
(10) Pub. No.: US 2018/0044966 A1
(43) Pub. Date: Feb. 15, 2018

(54) AUTOMATIC MECHANISM FOR SLIDING DOORS OR WINDOWS

(71) Applicant: SLIDER NEXT VISION LTD., Netanya (IL)

(72) Inventors: Dvir BRAND, Hod-Hasharon (IL); Gal SHNER, Kohav Michael (IL); Evgeny UMANSKY, Bat-Yam (IL)

(73) Assignee: SLIDER NEXT VISION LTD.

(21) Appl. No.: 15/236,438

(22) Filed: Aug. 14, 2016

(51) Int. Cl. E05F 15/643; E06B 3/46

(52) U.S. Cl. CPC E05F 15/643; E06B 3/4609; E06B 3/4636; E05Y 2201/434; E05Y 2201/652; E05Y 2201/71; E05Y 2600/46; E05Y 2900/132; E05Y 2900/148

(57) ABSTRACT

An automatic mechanism for operating sliding doors or windows, e.g., for fully or partially closing and fully or partially opening sliding doors or windows. Each of a plurality of sliding panes of doors or windows may comprise a corresponding automatic mechanism that may be operated independently of any of the other automatic mechanisms.

### TECHNICAL FIELD

The present invention relates to motorized automatic mechanism for operating sliding doors or windows.

### BACKGROUND

Sliding panes of doors and windows can be heavy and hard to move thus placing a burden on a user in opening and closing them or moving pane slabs from one state to another. This is especially problematic for children, elderly people and people with disabilities.

In some cases motors have been applied to mobilize the pane slabs to make it easier to open and close the door or window. Such motorized doors or windows may be typically present in entrances to public places, e.g., a mall or shopping center, a hospital, however, there is no good solution for motorized doors or windows for private households, which would enable ease of operation of doors or windows inside private homes, while being esthetic. Furthermore, most automatic mechanisms require installation of a new system incorporating the automatic mechanism. Therefore, there is a need for an automatic mechanism that may be installed in existing non-automatic doors or windows, in order to enable cheaper and quicker installation.

### SUMMARY

An aspect of an embodiment of the disclosure relates to a system comprising an automatic mechanism for easily operating sliding doors or windows within private households. Embodiments of the disclosure provide an automatic mechanism that may be quickly and simply installed in existing non-automatic sliding doors or windows in order to upgrade them to being automatic, or it may be installed as part of newly assembled doors or windows.

In one embodiment of the disclosure, a system for operating sliding doors or windows may comprise:
an opening of a door or window comprising an opening frame and at least one sliding pane, said sliding pane comprising a pane frame; and
an automatic mechanism for operating said sliding pane comprising:
   a motor positioned within a plane defined by the pane frame and corresponding to the sliding pane it is intended to move;
   a first pulley connected to the motor via at least one cogwheel, the first pulley positioned along the plane defined by the pane frame;
   a second pulley located adjacent to the first pulley and on the same plane as the first pulley;
   a third pulley located adjacent to and on the same plane as the first pulley and the second pulley; and
   a belt wound around the first pulley, the second pulley and the third pulley, wherein the belt is attached to a sliding pane of a door or window;
wherein the first pulley is configured to pull the sliding pane via the belt, and further wherein the second pulley and the third pulley are configured to thread at least a portion of the belt through the opening frame, the opening frame at least partially passing through the pane frame.

In some embodiments, the first pulley may be a toothed pulley, the second pulley may be a toothed pulley, and the third pulley may be an idler pulley.

In some embodiments, the belt is selected from a group consisting of: a belt, a chain, a cable, and a toothed timing belt.

In some embodiments, the second pulley is located beneath the first pulley such that the axis of rotation of the second pulley is parallel to the axis of rotation of the first pulley, and further wherein the second pulley is displaced along an axis that is perpendicular to the axis of rotation of the first pulley.

In some embodiments, the automatic mechanism is connected to a tension modulator configured to maintain a predetermined tension, e.g., an initial minimum tension of the belt. In some embodiments, the automatic mechanism and the tension modulator are situated on the plane defined by the pane frame and corresponding to the sliding pane that the automatic mechanism is intended to operate.

In some embodiments, the belt is configured to pass through a belt fastener, such that the belt is fastened towards and threaded through the opening frame.

In some embodiments, the automatic mechanism is configured to fully or partially open, and fully or partially close the sliding pane of a door or window.

In some embodiments, the system comprises a plurality of sliding panes, each sliding pane positioned in parallel to any other sliding pane, further wherein each sliding pane is associated with a corresponding automatic mechanism, each automatic mechanism positioned in parallel to any other automatic mechanism. In some embodiments, the width of each of the automatic mechanisms is no more than the width of a corresponding pane frame that surrounds the sliding pane associated with each of the automatic mechanisms. In some embodiments, each of the plurality of automatic mechanism operates independently of operation of any other automatic mechanism.

In some embodiments, one of the plurality of automatic mechanisms performs any of the following operations: open, close, partially open, partially close or rest, while any other automatic mechanism simultaneously performs any of the following operations: open, close, partially open, partially close or rest.

In some embodiments, each of said first, second and third pulleys rotates around a first, second and third shaft, respectively. Each of said first, second and third shafts is positioned on the plane defined by the pane frame.

In some embodiments, the belt wounds around the first pulley, the second pulley, and the third pulley to create a U shaped loop in the belt, wherein the U shaped loop extends in the same plane as defined by the pane frame, in a direction away from the pane frame.

In some embodiments, the width of the automatic mechanism is no more than the width of the pane frame.

In some embodiments, access to the automatic mechanism is achieved through the bottom side of the top horizontal end of the pane frame.

### BRIEF DESCRIPTION OF THE DRAWINGS

The present disclosure will be understood and better appreciated from the following detailed description taken in conjunction with the drawings. Identical structures, elements or parts, which appear in more than one figure, are generally labeled with the same or similar number in all the figures in which they appear. It should be noted that the elements or parts in the figures are not necessarily shown to scale such that each element or part may be larger or smaller than actually shown.

FIG. 1 is a schematic illustration of an opening of a door or window with an opening frame and an upper horizontal cover, according to an embodiment of the disclosure;

FIG. 2A is a schematic front view of an automatic mechanism for operating sliding doors or windows and of a tension modulator, according to an embodiment of the disclosure;

FIG. 2B is a schematic perspective view of an automatic mechanism for operating sliding doors or windows and of a tension modulator, according to an embodiment of the disclosure;

FIG. 3 is a schematic front-view of an automatic mechanism for operating sliding doors or windows, according to an embodiment of the disclosure;

FIG. 4A is a schematic illustration of a motor, pulleys and cogwheels of an automatic mechanism for operating sliding windows or doors, positioned within a corresponding pane frame, according to an embodiment of the disclosure;

FIG. 4B, is a schematic illustration of a plurality of automatic mechanisms for operating sliding windows or doors, according to an embodiment of the disclosure;

FIG. 5 is a schematic illustration of an automatic mechanism for operating sliding doors or windows, according to an embodiment of the disclosure;

FIGS. 6A-6C are schematic illustrations of a belt fastener deployed in a sliding pane of a door or window, according to an embodiment of the disclosure;

FIGS. 7A-7B are schematic illustrations of a tension modulator deployed in an upper horizontal portion of a sliding pane of a door or window, according to an embodiment of the disclosure;

FIG. 8 is a schematic bottom-side view of a covering box of an automatic mechanism for operating sliding windows or doors, according to an embodiment of the disclosure;

FIG. 9 is a schematic bottom-side view of an automatic mechanism for operating sliding doors or windows, according to an embodiment of the disclosure;

FIGS. 10A-10B are schematic upper-side views of a cover of an automatic mechanism for operating sliding windows or doors located behind an upper horizontal cover and partially above a frame surrounding a sliding pane of a door or window, according to one embodiment of the disclosure;

FIG. 11 is a schematic bottom-side view of a bottom cover of an automatic mechanism for operating sliding doors or windows, according to an embodiment of the disclosure; and

FIG. 12 is a schematic front-view cross-section of cogwheels and a toothed belts of a plurality of automatic mechanisms for operating sliding doors or windows, according to an embodiment of the disclosure.

### DETAILED DESCRIPTION

In one embodiment of the disclosure, a system comprising an automatic mechanism for operating sliding panes of doors or windows is disclosed. The automatic mechanism comprises a motor to provide power for operating, e.g., opening and closing the sliding panes. The automatic mechanism may enable control of the degree of opening and closing of the sliding pane, e.g., whether opening or closing is partial or complete, and if partial, the mechanism may enable control of the amount of movement of the sliding pane to either the open state or the closed state.

In another embodiment of the disclosure, there may be more than one automatic mechanism, whereby each automatic mechanism corresponds to a specific sliding pane and a respective pane frame. Typically, the plurality of automatic mechanisms may be positioned in parallel to one another, while the sliding panes may also be positioned in parallel to one another. That is, each of the plurality of automatic mechanisms may be associated with a corresponding pane frame, each of the automatic mechanism being located in parallel to any other automatic mechanism, and each pane frame (and respective sliding pane) being located in parallel to any other pane frame (and respective sliding pane).

In some embodiments, each of the plurality of automatic mechanisms may be operated independently of any of the other automatic mechanisms. That is, a first sliding pane may be operated by its corresponding automatic mechanism to perform any one of the following operations: open, close or rest, while a second sliding pane may be simultaneously operated by its corresponding automatic mechanism to perform any one of the following operations: open, close or rest, independently of the kind of operation performed by the first sliding pane. More than two sliding panes, each operating via its respective automatic mechanism independently of operation of other sliding panes, may be implemented. In some embodiments, a first sliding pane may be configured to operate in relation to additional sliding panes in the same window or door, e.g., an ‘open door’ command initiated by a user may cause a plurality of panes to open, and/or a ‘close door’ command may cause a plurality of panes to close, e.g., sequentially or simultaneously with each other. Synchronization of movement of a plurality of panes may be performed by one central control unit, which may continuously monitor the position of each sliding pane and may thus enable movement of a plurality of sliding panes at substantially the same time period.

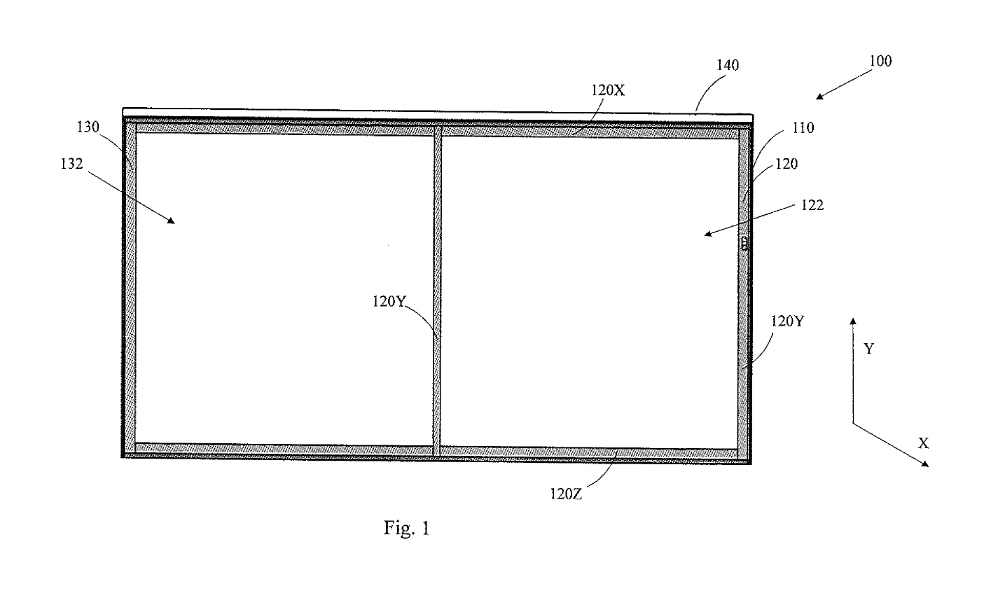

Reference is now made to FIG. 1, which schematically illustrates opening 100 of a door or window with an opening frame and an upper horizontal cover, according to an embodiment of the disclosure. According to FIG. 1, opening 100 may comprise opening frame 110, which may surround one or more sliding panes, e.g., sliding panes 122 and 132, which may also be referred to as inner sliding pane 132 and outer sliding pane 122. Opening frame 110 may have a rectangular shape, and may surround sliding panes, e.g., panes 122 and 132 from all sides, e.g., from the sliding panes' bottom horizontal portion, their upper horizontal portion, and both of their vertical portions.

The sliding panes 122 and 132 may be parallel to each other, and may be positioned on the same plane or on separate, parallel planes.

According to some embodiments, each of sliding panes 122 and 132 may comprise a pane frame 120 and 130, respectively. Pane frame 120 may surround all four sides of sliding pane 122, e.g., horizontal bottom portion (e.g., portion 120Z), horizontal upper portion (e.g., portion 120X) and both vertical portions (e.g., portions 120Y). Similarly, pane frame 130 may surround all four sides of sliding pane 132, e.g., horizontal bottom and upper portions and both vertical portions.

In some embodiments, opening frame 110 may comprise a cover 140, which may be located along the upper horizontal portion of opening frame 110. Upper horizontal cover 140 may be positioned between opening frame 110 and a wall (not shown) in which opening 100 may be installed. In some embodiments, cover 140 may cover an automatic mechanism for operating sliding doors or windows, as later disclosed in the present disclosure. In some cases, windows or doors have certain standard sizes, and in order to have enough space in which to place the automatic mechanism, cover 140 may be part of a box intended to house shades or blinds, and thus to further house the automatic mechanism, whereas in other cases opening frame 110 and thus sliding panes 122 and 132 may be of a shorter height as compared to standard height of doors or windows, in order to provide space for placement of the automatic mechanism. The space occupied by the automatic mechanism may be, for example, between 25 to 75 mm, e.g., 50 mm, thus the height of the door or window in which such an automatic mechanism is installed should be shortened within that same range.

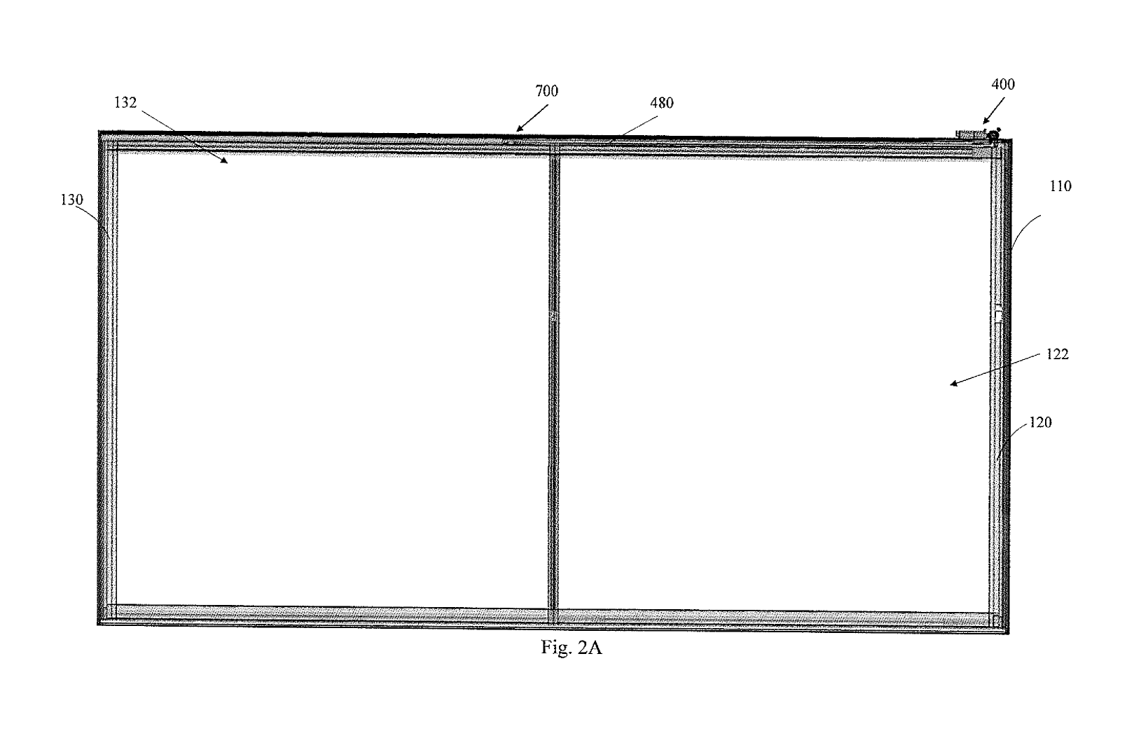

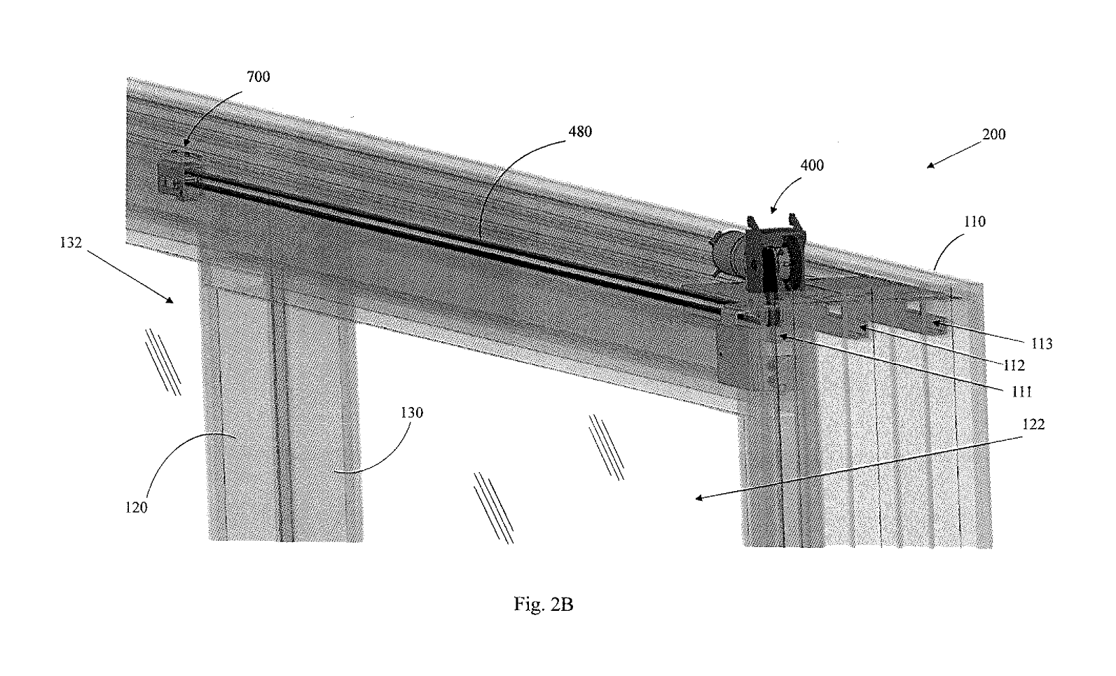

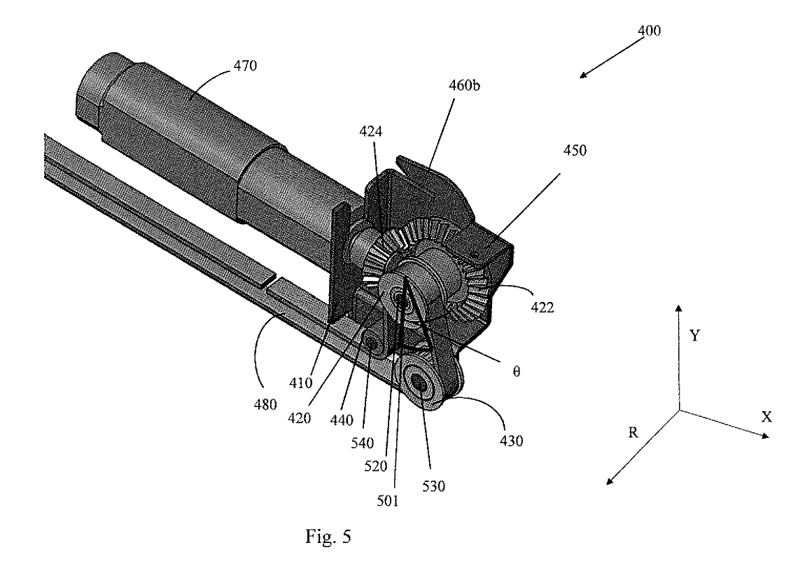

Reference is now made to FIG. 2A, which is a schematic front view of an automatic mechanism for operating sliding doors or windows and of a tension modulator, according to an embodiment of the disclosure. Automatic mechanism 400 may be located between opening frame 110 and its respective sliding pane which automatic mechanism 400 is designed to operate, e.g., sliding pane 122. Automatic mechanism 400 may be connected to tension modulator 700 through a belt, chain or cable 480. In some embodiments, belt 480 may be a timing belt or a toothed belt. The (toothed) belt 480 may be rotated around pulleys within automatic mechanism 400 (illustrated in detail with respect to FIG. 5) may further be twisted or looped around tension modulator 700, and may extend back towards and around automatic mechanism 400, such to create a loop around automatic mechanism 400 and tension modulator 700. Typically, toothed belt 480 may be configured to maintain a predetermined tension or tension range, e.g. a relatively high tension, or at least an initial minimum tension such that the belt 480 is tightly wrapped around all elements it is passing along so that automatic mechanism 400 may control and operate the opening and/or closing of its respective sliding pane properly with little to no malfunctions. In some examples, the tension of timing belt 480 may be configured to be maintained between 100 Newton to 800 Newton, though in other examples, other tension values may be implemented. Toothed belt 480 may typically pull the sliding pane to which it is connected, in order to cause its respective sliding pane to open or close (the direction of pulling of the toothed belt 480 of the sliding pane may determine the type of operation—whether to open the sliding pane or whether to close it).

According to some embodiments, each sliding pane may comprise a respective automatic mechanism (and a respective tension modulator), such that each sliding pane may be operated independently of any of the other sliding panes, if present. For example, (outer) sliding pane 122 may comprise a first automatic mechanism 400 and a first corresponding tension modulator 700, wherein the first automatic mechanism 400 and the first corresponding tension modulator 700 may be situated on the plane defined by pane frame 120, which surrounds sliding pane 122. Whereas, (inner) sliding pane 132 may comprise a second automatic mechanism (not shown) and a second corresponding tension modulator (not shown), wherein the second automatic mechanism and the second corresponding tension modulator may be situated on the plane defined by pane frame 130, which surrounds sliding pane 132.

Reference is now made to FIG. 2B, which is a schematic perspective view of an automatic mechanism for operating sliding doors or windows and of a tension modulator, according to an embodiment of the disclosure, which provides a closer view of the automatic mechanism and the tension modulator, compared to FIG. 2A. As can be seen in FIG. 2B, opening frame 110 may comprise a plurality of pane frames, e.g., outer pane frame 120, and inner pane frame 130. Other numbers of pane frames that slide along opening frame 110 may be implemented. In some embodiments, each pane frame may slide along a respective guide, which is protruding along the plane of the opening frame 110. For example, outer sliding pane 122 that is surrounded by pane frame 120 may slide along guide 111. In order for outer sliding pane 122 to slide along guide 111, the pane frame 120 surrounding sliding pane 122 may comprise a corresponding tunnel that guide 111 may slide through. Similarly, guide 112 may slide along a corresponding tunnel (not shown) passing through inner pane frame 130. In case there is an additional third sliding pane, its corresponding guide 113 may slide along a respective tunnel (not shown) along its respective pane frame (not shown).

In some embodiments, the size, e.g., width of automatic mechanism 400 may be configured to substantially extend such to conform to no more than the width of the foot-print of the pane frame. For example, the width of automatic mechanism 400 may be of substantially the same or no more than the width of pane frame 120. Similarly, any other automatic mechanism that may be added to the system 200 may be of a width of no more than the width of the pane frame surrounding the sliding pane it is to operate. This enables to position a limitless number of automatic mechanisms side by side, typically positioned in parallel to one another, and thus allows independent operation of each of the sliding panes, since each automatic mechanism doesn't interfere with the position and thus operation of any of the other automatic mechanisms, all of which may be positioned on the upper horizontal portion of pane frame 120.

In some embodiments, timing belt 480 may pass along the existing space within the opening frame's guide. For example, timing belt 480 may pass along the inner space within guide 111. This is ideal since instead of creating a space through which to insert the timing belt, the existing space within guide 111 is utilized for insertion of timing belt 480.

In some embodiments, timing belt 480 may be looped around automatic mechanism 400 and around tension modulator 700. Automatic mechanism 400 may be located on top of the upper horizontal portion of opening frame 110, while tension modulator may be positioned along the bottom side of the upper horizontal portion of opening frame 110, such that one section of timing belt 480 passes above another section of timing belt 480.

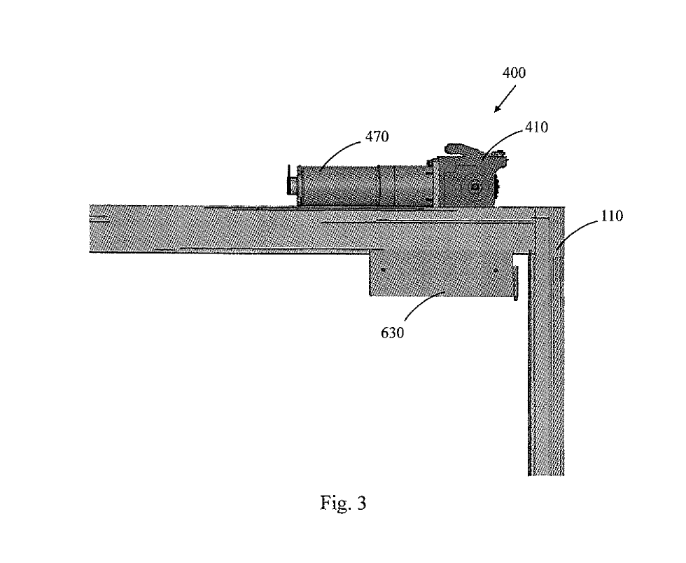

Reference is now made to FIG. 3, which is a schematic front-view of an automatic mechanism for operating sliding doors or windows, according to an embodiment of the disclosure. In some embodiments, automatic mechanism 400 may be located on or within opening frame 110 of a sliding door or window. Automatic mechanism 400 may comprise a motor 470, for enabling motorized operation of the sliding door or window that automatic mechanism 400 is connected to. Motor 470 may be powered by a power source, e.g., a battery (not shown) and thus would require no wires. However, in other embodiments, motor 470 may be powered via wires to an electrical system, e.g., the main electrical system of the building that houses the sliding doors or windows thereby further housing automatic mechanism 400.

In some embodiments, automatic mechanism 400 may comprise a base 410, which may protect and keep all the inner components of automatic mechanism 400 intact and clean.

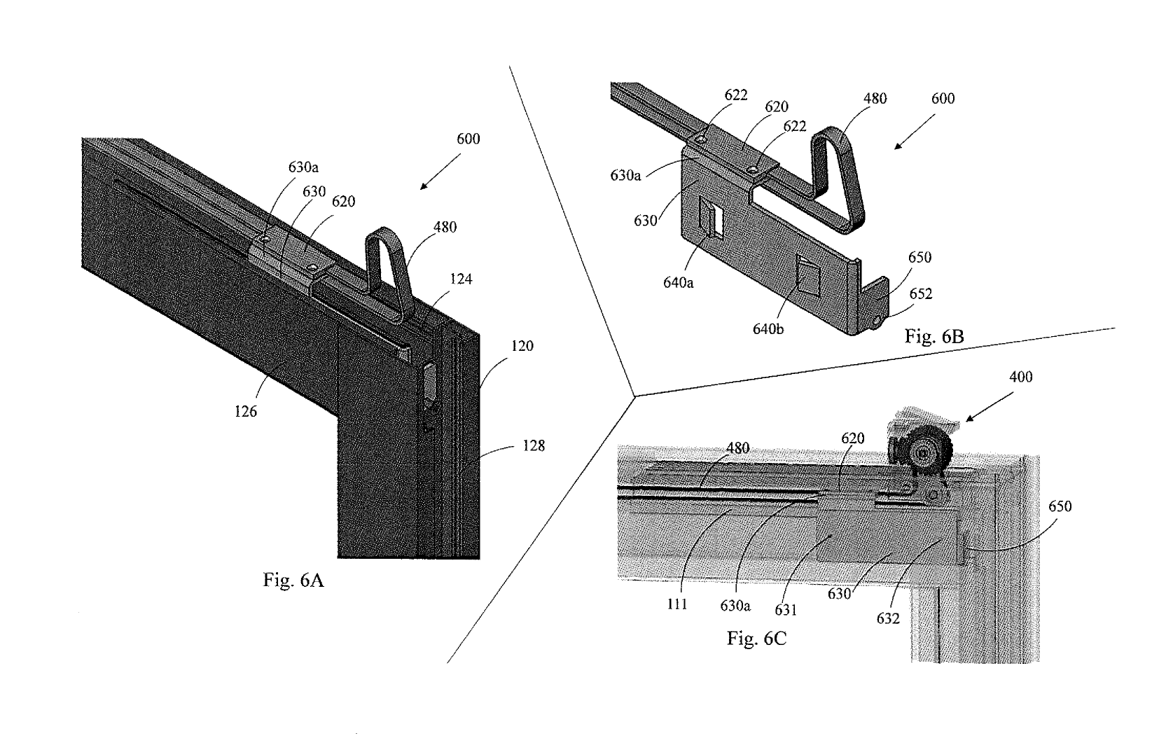

In some embodiments, belt to pane connection plate 630 may be part of belt fastener 600 (FIGS. 6A-6C). Belt to pane connection plate 630 may be configured to connect the toothed belt 480 to the sliding pane, e.g., sliding pane 122, which automatic mechanism 400 is intended to pull via toothed belt 480, as will be explained in detail with respect to FIGS. 6A-6C.

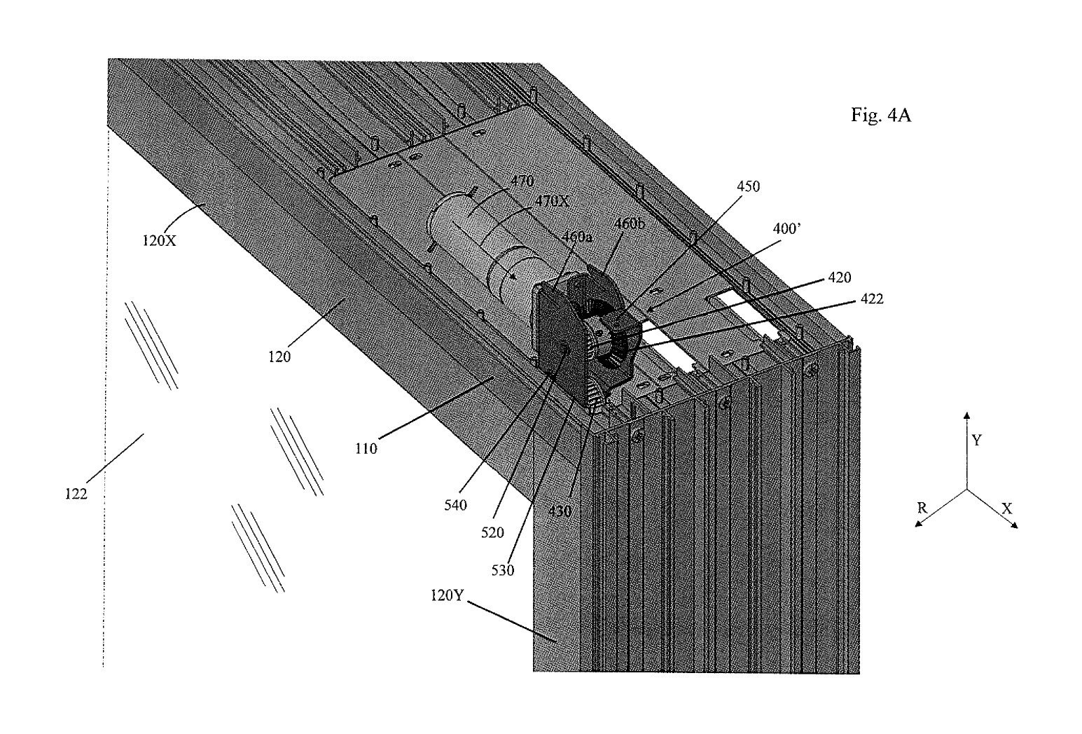

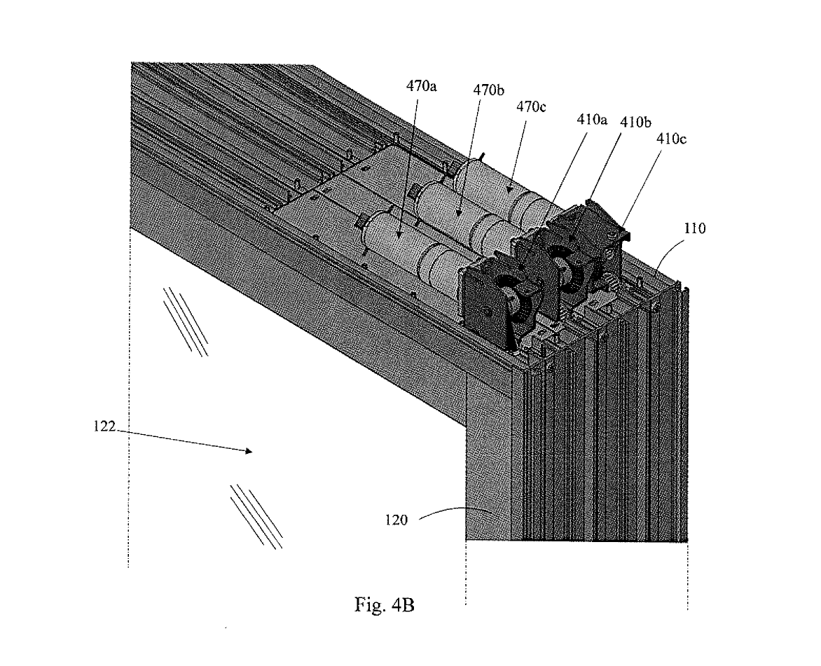

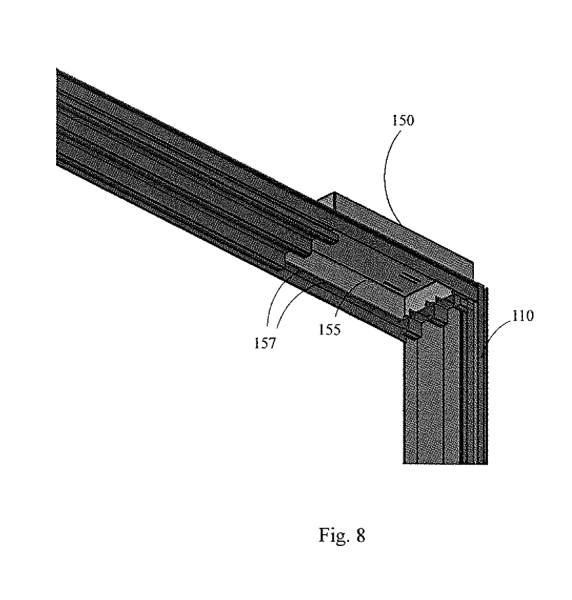

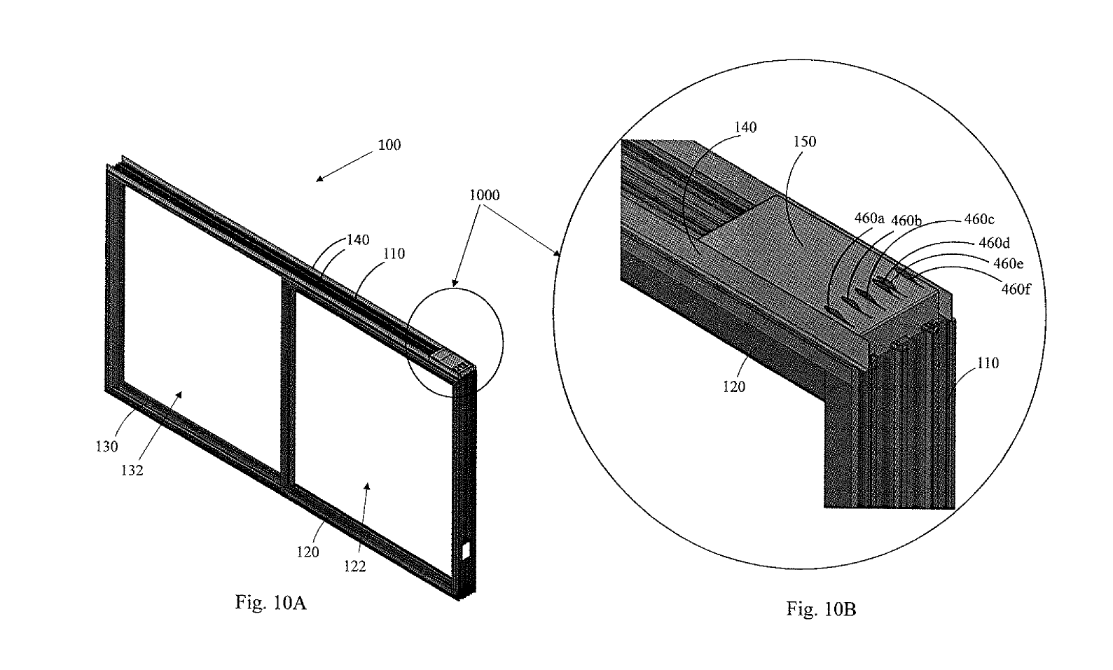

Reference is now made to FIG. 4A, which schematically illustrates a motor, pulleys and cogwheels of an automatic mechanism for operating sliding windows or doors, positioned within a corresponding pane frame, according to an embodiment of the disclosure. In some embodiments, unit 400′ comprises only several elements of the entire automatic mechanism 400. Unit 400′ may comprise base 410, which may keep all components of unit 400′ intact, and may have all components of automatic mechanism 400 attached to it, for ease of attachment of automatic mechanism 400 into the upper horizontal end of the opening frame, e.g., attachment as one unit instead of several separate units. Base 410 may comprise two (or more) protrusions 460a and 460b, which may be configured to be attached and fastened to covering box 150 (see FIGS. 10A-10B). Base 410 may further comprise element 450, which may be designed to be nailed, screwed or riveted to covering box 150 (described later in FIG. 8), in order to provide stability to the automatic mechanism and to opening frame 110, into which the automatic mechanism is installed.

Unit 400′ may comprise motor 470, which may be configured to provide power for the operation of the sliding panes of the doors or windows. In some embodiments, motor 470 may be located in a niche along a portion of opening frame 110 (niche 155, FIG. 8), positioned as part of a plane corresponding to the sliding pane it is intended to operate and move. Unit 400′, as does automatic mechanism 400, may be aligned with, or positioned within, a plane defined by a pane frame, e.g., pane frame 120, such that the sliding pane, e.g., sliding pane 122, which unit 400′ (or automatic mechanism 400) is intended to move and operate is positioned within the same plane defined by pane frame 120.

According to some embodiments, motor 470 may be positioned substantially within the plane defined by the pane frame 120, such that a longitudinal axis 470X of motor 470 is adjacent to and parallel to the top horizontal portion 120X of pane frame 120, which surrounds the sliding pane, e.g., sliding pane 122 that motor 470 is intended to move. In other embodiments, longitudinal axis 470X of motor 470 may be positioned adjacent to and perpendicularly to the top horizontal portion 120X of pane frame 120, which surrounds the sliding pane that motor 470 is intended to operate and move, e.g., sliding pane 122. In yet other embodiments, longitudinal axis 470X of motor 470 may be positioned adjacent to and at an angle with respect to the top horizontal portion 120X of pane frame 120, which surrounds the sliding pane it is intended to operate, e.g., sliding pane 122. According to some embodiments, longitudinal axis 470X of motor 470 may be positioned adjacent to the top horizontal portion 120X of pane frame 120, whereas in other embodiments motor 470 may be located adjacent to other locations along pane frame 120, e.g., at the bottom horizontal portion 120Z (FIG. 1) of pane frame 120, or at a bottom portion or a top portion of either of the vertical portions 120Y of pane frame 120.

In some embodiments, motor 470 may be connected to a first pulley 420 via at least one cogwheel, e.g., cogwheel 422 and cogwheel 424 (in FIG. 5). First pulley 420 may be a toothed pulley. Other numbers of cogwheels configured to transfer the energy and motion from motor 470 to first (toothed) pulley 420, may be used. In some embodiments, first toothed pulley 420 may be rotated around an axis of rotation that is parallel to axis R, around first shaft 520, which may be connected to base 410. First shaft 520 may be positioned adjacent to and perpendicularly to the top horizontal portion 120X of pane frame 120.

Unit 400′ may further comprise a second pulley 430, which may rotate around an axis of rotation that is parallel to axis R, around second shaft 530. Second pulley 430 may be a toothed pulley. Second shaft 530 may be connected to base 410, and may be positioned adjacent to and perpendicularly to the top horizontal portion 120X of pane frame 120. In some embodiments, second shaft 530 may further be biased or offset with respect to the location of first shaft 520 along axes X and Y. A third shaft 540, which third pulley 440 (FIG. 5) may rotate around, may be connected to base 410. Third pulley 440 may be an idler pulley. In some embodiments, third shaft 540 may be positioned adjacent to and perpendicularly to the top horizontal portion 120X of pane frame 120. In some embodiments, third shaft 540 may rotate around an axis of rotation that is parallel to axis R and may be biased or offset with respect to the location of any of first shaft 520 and second shaft 530, along axes X and Y. Shafts 520, 530 and 540 may be positioned on the same plane, which may be the same plane defined by pane frame 120.

Reference is now made to FIG. 4B, which schematically illustrates a plurality of automatic mechanisms for operating sliding windows or doors, according to an embodiment of the disclosure. FIG. 4B illustrates three automatic mechanisms, though any other number may be implemented, as long as the number of automatic mechanisms conform to the number of sliding panes that the automatic mechanisms are supposed to operate. That is, each sliding pane is associated with an automatic mechanism for operating movement of the sliding pane, typically independently of operation of any other automatic mechanism.

In one embodiment, the sliding panes may be located in parallel to one another, and each automatic mechanism may be located such to be positioned within or aligned with a plane defined by a pane frame that surrounds its corresponding sliding pane. Therefore, the plurality of automatic mechanisms may also be positioned in parallel with respect to one another. As illustrated in FIG. 4B, and as explained with respect to FIG. 2B, the maximum width of each automatic mechanism is the width of the pane frame surrounding the sliding pane. That is, the width of each automatic mechanism is no more than the width of the corresponding pane frame that the automatic mechanism is aligned with or positioned within. This enables each of the automatic mechanisms to operate independently of any of the other mechanisms, such that each sliding pane may move independently of motion of any other sliding pane. The width of the automatic mechanism being no larger than the width of each pane frame surrounding either of the sliding panes, also provides ease of implementation of the automatic mechanisms within the pane frame and opening frame.

For example, a first automatic mechanism may comprise motor 470a connected to base 410a, while a second automatic mechanism may comprise motor 470b connected to base 410b, and a third automatic mechanism may comprise motor 470c connected to base 410c. As illustrated in FIG. 4B, motor 470a may be positioned in parallel to motor 470b and in parallel to motor 470c. Furthermore, base 410a may be positioned in parallel to base 410b, as well as in parallel to base 410c.

In some embodiments, each of the automatic mechanisms may comprise the respective motor and base serially connected to one another, such that the entire first mechanism comprising motor 470a connected to base 410a may be positioned in parallel with respect to the second mechanism, which comprises motor 470b connected to base 410b. Furthermore, the first automatic mechanism and the second automatic mechanism may be positioned in parallel to the third automatic mechanism, which comprises motor 470c serially connected to base 410c.

Reference is now made to FIG. 5, which schematically illustrates an automatic mechanism for operating sliding doors or windows, according to an embodiment of the disclosure. Automatic mechanism 400 may comprise motor 470, first pulley 420 and second pulley 430 and their respective shafts, which pulleys 420 and 430 rotate around, e.g., respective first and second shafts 520 and 530, and cogwheels 422 and 424. In addition, automatic mechanism 400 may comprise a third shaft 540 and a third pulley 440 that rotates around third shaft 540, and a belt, e.g., timing belt 480, which may be wound around the first pulley 420, second pulley 430, and third pulley 440 to create a U shaped loop in the timing belt 480, the U shaped loop extending in the same vertical plane as the sliding pane 122, in a direction away from the pane frame 120. In some embodiments, pulleys 420, and 430 may have teeth or protrusions all around the pulley in order for the toothed belt 480 to turn around the pulleys without slipping off them, or slipping along the pulleys, during the turning motion of the pulleys caused by motor 470. The toothed belt 480 may be configured to turn around the toothed pulleys 420 and 430 such that the protrusions of toothed belt 480 fit into the dents in each of the toothed pulleys, and the dents of toothed belt 480 accept the protrusions of each of the toothed pulleys. In some embodiments, third pulley 440 may be an idler pulley.

In some embodiments, motor 470 is configured to rotate cogwheel 424 around an axis of rotation, e.g., around an axis parallel to axis X. Cogwheel 422 is then turned by cogwheel 424 around a different perpendicular axis of rotation, e.g., around an axis parallel to axis R. In some embodiments, first toothed pulley 420 turns around an axis of rotation that is parallel to the axis of rotation of cogwheel 424, e.g., around an axis parallel to axis R, since first toothed pulley 420 is directly connected to cogwheel 424. First toothed pulley 420 as does cogwheel 424 may be located within a vertical plane that is defined by pane frame 120, which surrounds sliding pane 122. First toothed pulley 420 may rotate around first shaft 520, which may be connected to base 410 such that first shaft 520 may be positioned in parallel to the axis of rotation of first toothed pulley 420.

In some embodiments, second toothed pulley 430 may be positioned adjacent to the first toothed pulley 420 and on substantially the same plane as the plane on which first toothed pulley 420 is positioned, e.g. within a vertical plane that is defined by pane frame 120, which surrounds sliding pane 122. In some embodiments, second toothed pulley 430 may be positioned beneath first toothed pulley 420 along the vertical axis Y, and further such that second toothed pulley 430 is offset along the axis X on which the first toothed pulley 420 is located, in a direction opposite from motor 470. In some embodiments, second toothed pulley 430 may rotate around second shaft 530. Second shaft 530 may be positioned in parallel to the axis of rotation of second toothed pulley 430.

In some embodiments, second toothed pulley 430 may be positioned beneath first toothed pulley 420 at a distance from the location of first toothed pulley 420, e.g., further along axis X in a direction opposite from motor 470, such that toothed belt 480 may be wound around first toothed pulley 420 and then divert on an angle θ in order to proceed to wound around second toothed pulley 430. In some examples, angle θ may be between −45° to +80°, whereby the angles denoted with ‘minus’ are angles that extend from vertical line 501 towards motor 470, whereas the angles denoted with ‘plus’ are ones that extend from vertical line 501 towards the direction opposite motor 470, similarly to the illustrated angle θ in FIG. 5, which is a ‘plus’ indicated angle. In other examples, other degrees may be implemented for θ. In some embodiments, the axis of rotation of second toothed pulley 430 may be parallel to the axis of rotation of the first toothed pulley 420, along a vertical plane that is defined by pane frame 120 which surrounds the sliding pane, e.g., sliding pane 122. Furthermore, the position of the second toothed pulley 430 may be displaced or offset from the position of the first toothed pulley 420 along an axis that is on the plane defined by the pane frame and corresponding to the sliding pane 122 and perpendicular to the axis of rotation of the first toothed pulley 420.

In some embodiments, the third pulley 440, e.g., idler pulley 440 may be positioned on the same plane as the plane at which first toothed pulley 420 and second toothed pulley 430 are positioned. In addition, idler pulley 440 may be positioned adjacent to the first toothed pulley 420 and adjacent to the second toothed pulley 430. In some embodiments, idler pulley 440 may further be located in between the location of the first toothed pulley 420 and the location of the second toothed pulley 430, along axis Y. The idler pulley 440 may be positioned above second toothed pulley 430 while at a displacement or offset along axis X from the location of second toothed pulley 430, e.g., not directly above the X axis coordinate of second toothed pulley 430.

The idler pulley 440 may further be positioned beneath the first toothed pulley 420 along axis Y, along a vertical plane defined by pane frame 120, and corresponding to sliding pane 122. Idler pulley 440 may typically be positioned at a displacement along axis X from the location of the first toothed pulley 420, e.g., not directly beneath the X axis coordinate of first toothed pulley 420. In some embodiments, the axis of rotation of the idler pulley 440 may be parallel to the axis of rotation of the first toothed pulley 420, which may further be parallel to the axis of rotation of the second toothed pulley 430, along a vertical plane defined by pane frame 120, which surrounds sliding pane 122. In some embodiments, idler pulley 440 may rotate around third shaft 540. Third shaft 540 may be parallel to the axis of rotation of idler pulley 440.

Furthermore, the position of idler pulley 440 may be displaced or offset from the position of the first toothed pulley 420 along an axis that is perpendicular to the axis of rotation of the first toothed pulley 420, as well as being displaced from the position of the second toothed pulley 430 along an axis that is perpendicular to the axis of rotation of the second toothed pulley 430.

In some embodiments, all the pulleys 420, 430 and 440 may be positioned on the same plane, e.g., the same plane defined by pane frame 120. Each toothed pulley may be offset with respect to the other two pulleys, the offset being both along the X axis and along the Y axis of the plane in which the toothed pulleys are positioned. The shafts of the toothed pulleys may be positioned along an axis that is parallel to the axis of rotation of the corresponding pulleys. According to some embodiments, the idler pulley 440 may be positioned such that toothed belt 480 is wound beneath idler pulley 440, and continues in a straight line upwards along axis Y towards the upper side of the first toothed pulley 420, and then continues to be wound at an angle θ around the bottom side of the second toothed pulley 440. Other embodiments may implement other positioning and locations for any of the pulleys and the toothed belt 480 that is wound around them.

In some embodiments, the toothed belt 480 may be positioned such that it is parallel to the upper horizontal portion of opening frame 110. In some embodiments, the direction of motion of toothed belt 480 is parallel to the direction of motion of the sliding pane that toothed belt 480 is configured to operate.

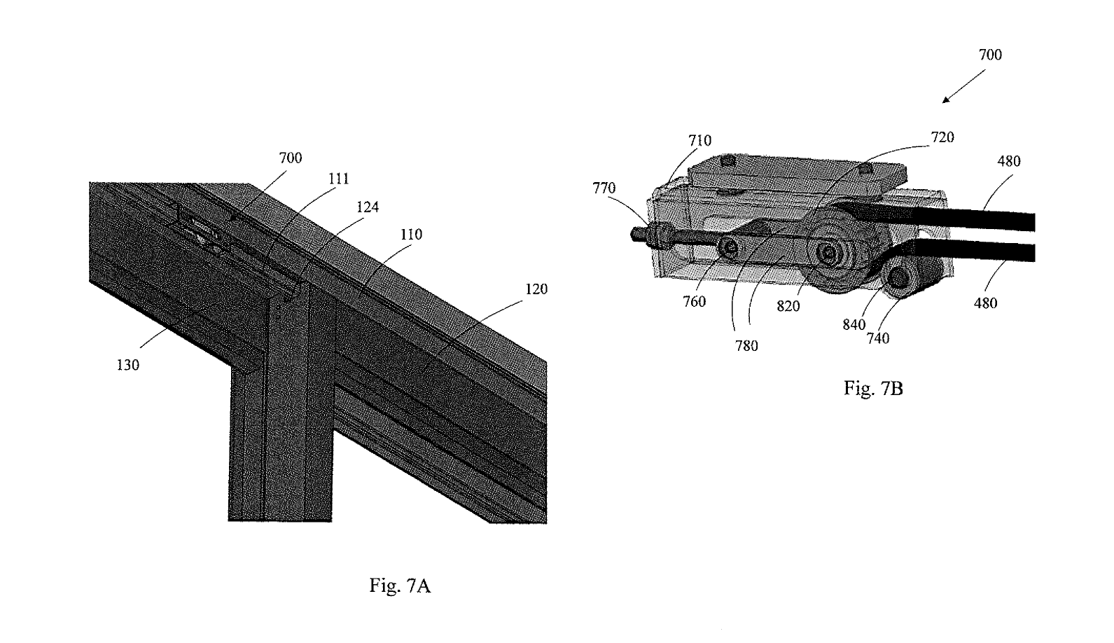

According to some embodiments, the first toothed pulley 420 may be located behind upper horizontal cover 140 (FIG. 1), which means it is located above the opening frame 110 (FIG. 1). However, the second toothed pulley 430, as well as the idler pulley 440 may be located within opening frame 110 such to contact the pane frame of a sliding pane, e.g., pane frame 120 or pane frame 130, and thus to be able to operate (open or close) a corresponding sliding pane, e.g., sliding pane 122 or sliding pane 132, respectively. In some embodiments, the toothed belt 480 may be threaded through a guide (e.g., guide 111, FIGS. 6C, 7A), which passes along an upper horizontal portion of the opening frame, e.g., opening frame 110, such to allow the toothed belt 480 to pass through the guide, which may be in the form of a protrusion located along the opening frame.

In some embodiments, in order to thread timing belt 480 through guide 111, a hole is to be made, such to obtain access to guide 111. Timing belt 480 may be located between the opening frame and the pane frame since timing belt 480 passes along a guide that is part of the opening frame, while the guide may slide along a corresponding tunnel that is part of the pane frame. In a preferred embodiment, toothed belt 480 may pass through a guide, e.g., guide 111 (FIG. 7A), which passes along the upper horizontal portion of the opening frame in order for the sliding pane that comprises a tunnel 124 to slide over the corresponding guide 111 of opening frame 110, during opening and/or closing operation of the sliding pane.

When motor 470 receives a command of ‘open door/window’ or ‘close door/window’, motor may cause cogwheels 424 and 422 to turn, thus turning first toothed pulley 420, which causes toothed belt 480 to turn along with the first toothed pulley 420, and this may cause second toothed pulley 430 as well as idler pulley 440 to turn around. The direction in which toothed belt 480 is turned at, may be dictated by the direction of turning of motor 470, which may correspond to the type of operation required, e.g., whether it is to open the sliding pane or whether it is to close it. In some cases, for example with respect to sliding pane 122, the direction of opening sliding pane 122 may be to the left (FIG. 1), whereas the direction of closing the sliding pane 122 is to the right. However, with respect to sliding pane 132, the direction of opening sliding pane 132 may be to the right (FIG. 1), whereas the direction of closing the sliding pane 122 is to the left. In case there are additional sliding panes, the direction of opening or closing these sliding panes may be determined with respect to the other sliding panes. When motor 470 receives a command to stop movement of the sliding pane, it may stop operation of all cogwheels and pulleys, thus putting the automatic mechanism 400 at rest.

Reference is now made to FIGS. 6A-6C, which are schematic illustrations of a belt fastener deployed in a sliding pane of a door or window, according to an embodiment of the disclosure. FIGS. 6A and 6C illustrate belt fastener 600 when deployed in a sliding pane frame, e.g., sliding pane frame 120, and FIG. 6B illustrates additional elements included in belt fastener 600. According to some embodiments, belt fastener 600 may comprise two main elements: belt clamp plate 620 and belt to pane connection plate 630, which may be connected to one another (e.g., via connectors located in holes 622). Belt clamp plate 620 may be located on the top horizontal portion of the sliding pane, while the main part of belt to pane connection plate 630 may be located behind the front side of the horizontal portion of the sliding pane such that the main part of belt to pane connection plate 630 is located perpendicularly to belt clamp plate 620.

Timing belt 480 may be wound around several toothed pulleys and possibly an idler pulley (see FIGS. 4A-4B and 5) prior to passing along the opening frame, e.g., opening frame 110, on its way to reach tension modulator 700, and then back to automatic mechanism 400, thus creating a full loop. In some embodiments, toothed belt 480 may be designed to pass through a guide passing along the upper horizontal portion of opening frame 110, e.g., guide 111. The guide 111 positioned along the opening frame 110 is an integral part of the opening frame, and it may slide along tunnel 124, which is an integral part of pane frame 120, such to enable the sliding pane to slide along the opening frame 110. In some embodiments, toothed belt 480 may be positioned parallel to guide 111. In some embodiments, toothed belt 480 may pass through guide 111, between opening frame 110 and pane frame 120.

In some embodiments, as illustrated in FIG. 6C, belt to pane connection plate 630 may attach timing belt 480 to the pane frame surrounding the sliding pane that timing belt 480 is intended to pull, via belt clamp plate 620. Belt clamp plate 620 may tightly attach timing belt 480 to the pane frame, e.g., pane frame 120 by being connected to belt to pane connection plate 630, which is further connected to pane frame 120. On one end of belt to pane connection plate 630, belt to pane connection plate 630 may be attached to pane frame 120 via connectors 631 and 632, which may be screws, rivets, nails or any other attachment means. On another end of belt to pane connection plate 630, belt to pane connection plate 630 may be connected to timing belt 480 via belt clamp plate 620. That is, pane frame 120 is connected to the upper portion of timing belt 480, whereas the lower portion of timing belt 480 is not attached to pane frame 120. When automatic mechanism 400 operates rotation of timing belt 480, the upper portion of timing belt 480 may pull pane frame 120 and may thus pull sliding pane 122 along with it, to either direction that the upper portion of timing belt 480 is directed to move, whereas the lower portion of timing belt 480 may be free to move to a direction that is opposite the direction towards which the upper portion of timing belt 480 rotates.

In some embodiments, toothed pulley 420 and toothed pulley 430 may be configured to pull the sliding pane (e.g., sliding pane 122) via the pane frame (e.g., pane frame 120), whereas the idler pulley 440 may be configured to orient timing belt 480 into guide 111.

The toothed belt 480 may continue to pass along guide 111 until reaching the tension modulator 700, may turn around the tension modulator 700 and then return back towards automatic mechanism 400, thus creating a loop around both automatic mechanism 400 and tension modulator 700.

In some embodiments, belt clamp plate 620 may be connected to belt to pane connection plate 630 via section 630a through connectors, e.g., screws, bolts, nails, rivets, glue, etc. When using connectors that need to pass through belt clamp plate 620 and section 630a, e.g., screws, bolts and so on, belt clamp plate 620 may comprise holes 622 through which to insert such connectors. Other numbers and/or shapes of holes may be implemented. Section 630a may comprise corresponding holes in order to enable ease of insertion of such connectors.

In some embodiments, belt to pane connection plate 630 may comprise protrusions 640a and 640b, which are configured to adjust the width of belt to pane connection plate 630 to the space it is placed within, e.g., per various pane frame profiles. In some embodiments, belt to pane connection plate 630 may comprise an extension 650 which may be attached to belt to pane connection plate 630 at an angle, for example, at an angle of 90°, if extension 650 is to be attached to the side of the sliding pane, e.g., to side 128 of sliding pane 122, which is perpendicular to tunnel 124 that is located at the upper horizontal portion of pane frame 120. In order to firmly attach extension 650 to sliding pane side 128, a connector(s) may be used, e.g., glue, screws, rivets, bolts, nails, etc. In order to use a connector that is to be inserted into side 128, extension 650 may comprise a hole 652. Other numbers of holes may be implemented.

Reference is now made to FIGS. 7A-7B, which are schematic illustrations of a tension modulator deployed in an upper horizontal frame of a sliding pane of a door or window, according to an embodiment of the disclosure. In some embodiments, tension modulator 700 may be located at the upper horizontal portion of opening frame 110. Typically, tension modulator 700 may be located at the bottom side of the upper horizontal portion, between the horizontal portion of the opening frame 110 and the sliding panes' frames, e.g., pane frame 120 and pane frame 130. In some embodiments, tension modulator 700 may be located along guide 111 of opening frame 110. In some embodiments, guide 111 may be cut such to provide space for tension modulator 700 to be inserted along guide 111.

In some embodiments, tension modulator 700 may comprise a pulley 720, which toothed belt 480 may wound around. In some embodiments, pulley 720 may be a toothed pulley. Tension modulator 700 may further comprise a pulley 740, which may be intended to lead the toothed belt 480 into the correct position in guide 111 through which the toothed belt 480 passes on its way back towards the automatic mechanism 400 (and through which the toothed belt passed in order to reach the tension modulator 700). In some embodiments, pulley 740 may be an idler pulley. Pulley 720 may rotate around shaft 820, while pulley 740 may rotate around shaft 840.

In some embodiments, tension modulator 700 may comprise base 710, which may house or encapsulate substantially the entirety of the components that tension modulator 700 comprises. Base 710 may be made of different materials, typically solid, e.g., metal and/or plastic. Base 710 may be designed to be opened relatively easily, in order to enable access to any of the components encapsulated within it, in any case of malfunction of operation of tension modulator 700, or for standard maintenance of tension modulator 700.

According to the example illustrated in FIG. 7B, the toothed belt 480 is lead to pass over and above pulley 740, in order to travel through guide 111. In some embodiments, tension modulator 700 may further comprise element 760 which may be attached on both of its ends to both ends of shaft 820 via connectors 780. Connectors 780 may be positioned parallel to one another, if and when the width of element 760 is identical to the length of shaft 820. In some embodiments, element 760 may comprise a screw 770 located at an end of element 760, externally to base 710. In order to change the tension along timing belt 480, screw 770 may either be screwed along element 760 towards base 710 or it may be unscrewed along element 760 away from base 710, such to adjust the tension as necessary. The tension of timing belt 480 remains substantially the same as long as there is no active change in the location of screw 770 along element 760. That is, the tension modulator 700 is configured to maintain a predetermined tension, e.g., an initial minimum tension along belt 480. When there is a need or desire to change the tension of the timing belt, there is a need to access the tension modulator and adjust screw 770, e.g., by turning screw 770 either towards or away from base 710.

Reference is now made to FIG. 8, which is a schematic bottom-side view of a covering box of an automatic mechanism for operating sliding windows or doors, according to an embodiment of the disclosure. In some embodiments, a niche 155 may be created within opening frame 110 behind covering box 150, into which the automatic mechanism may be placed. FIG. 8 illustrates the covering box 150, which covers automatic mechanism 400, from a bottom-side view, while automatic mechanism 400 is not shown. Covering box 150 may be firmly connected to opening frame 110, once positioned such to create niche 155, in order to provide opening frame 110 with enough strength that may have weakened due to presence of niche 155, which includes a hole along opening frame 110. For example, covering box 150 may be connected to opening frame 110 via rivets 157, such that opening frame 110 may regain its stability and strength, which deteriorated following the creation of niche 155.

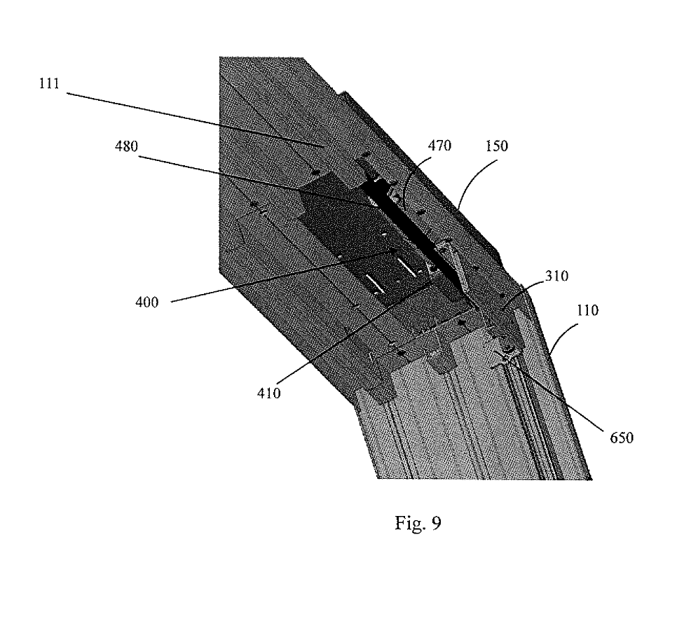

Reference is now made to FIG. 9, which is a schematic bottom-side view of an automatic mechanism for operating sliding doors or windows, according to an embodiment of the disclosure. According to some embodiments, automatic mechanism 400 may be positioned beneath covering box 150, within opening frame 110. Covering box 150 may cover all elements of automatic mechanism 400, e.g., motor 470, toothed belt 480 and all inner elements (e.g., the various pulleys and cog wheels), which are protected by base 410.

FIG. 9 further illustrates plate 310, which is located perpendicular to covering box 150, and further located perpendicular to the longitudinal axis of automatic mechanism 400. Plate 310 may be used when there is a need to close a gap that might be present, between the automatic mechanism and the pane frame surrounding the sliding pane that the automatic mechanism is intended to pull. Plate 310 may be connected to belt to pane connection plate 630 via means of connection, e.g., glue, screws, rivets, bolts, nails and so on.

FIG. 9 further illustrates timing belt 480 passing along the space within guide 111, which is part of opening frame 110.

Reference is now made to FIGS. 10A and 10B, which are schematic upper-side views of a cover of an automatic mechanism for operating sliding windows or doors located behind an upper horizontal cover and partially above a frame surrounding a sliding pane of a door or window, according to one embodiment of the disclosure. According to FIG. 10A, cover 140 may be located above opening frame 110. In some embodiments, expanded view 1000 illustrates cover 140 behind which an automatic mechanism, e.g., automatic mechanism 400, is located. The automatic mechanism may comprise a covering box 150 configured to protect the automatic mechanism from any damage that may be caused if left open, such as entry of dirt, moist, etc. As illustrated in FIG. 10B, elements 460a and elements 460b may protrude out of covering box 150, since, as explained with respect to FIG. 4A, these elements are part of the container housing the automatic mechanism 400, and these protruding elements 460a and 460b may be configured to align placement of automatic mechanism 400 within the guide, e.g., guide 111 (FIG. 2B) of opening frame 110, since they are parallel to the plane of automatic mechanism 400, and thus enable placement of automatic mechanism 400 in parallel to the guide. In addition, protruding elements 460a and 460b may be configured to enable initial placement of automatic mechanism 400 without the immediate need for fastening means, since the protruding elements 460a and 460b may be inserted into covering box 150 in a tight manner. After final alignment of automatic mechanism 400 within guide 111, fastening means may be added in order to ensure safe and secure attachment of automatic mechanism 400 to the top horizontal portion of opening frame 110.

Similarly, when there is more than one sliding pane, each of the sliding panes may comprise a corresponding automatic mechanism that may operate independently of operation of the other automatic mechanisms, and thus each of the automatic mechanisms may comprise corresponding protruding elements. For example, in case there are three parallel sliding panes, then the first sliding pane may comprise respective protruding elements 460a and 460b, the second sliding pane may comprise respective protruding elements 460c and 460d, and the third sliding pane may comprise respective protruding elements 460e and 460f. According to some embodiments, each of the sets of two protruding elements may be part of an independent stand-alone automatic mechanism. In some embodiments, other numbers of protruding elements may be associated with each automatic mechanism.

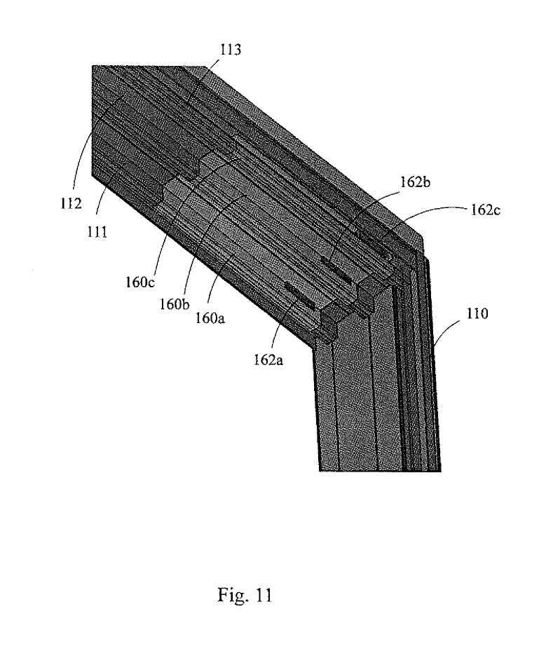

Reference is now made to FIG. 11, which is a schematic bottom-side view of a bottom cover of an automatic mechanism for operating sliding doors or windows, according to an embodiment of the disclosure. FIG. 11 illustrates the lower cover per each of the automatic mechanisms, which may be located within opening frame 110. For example, a first automatic mechanism, which is associated with a first sliding pane, may be covered with covering box 150 (FIG. 8) and bottom cover 160a. Similarly, a second automatic mechanism, which is associated with a second sliding pane (typically parallel to the first sliding pane) may be covered with covering box 150 and bottom cover 160b, and a third automatic mechanism, which is associated with a third sliding pane (typically parallel to the first and second sliding panes) may be covered with covering box 150 and bottom cover 160c.

In some embodiments, each of the bottom covers may be firmly connected to opening frame 110, in order for each bottom cover to stay in place during operation of the sliding panes.

In some embodiments, each bottom cover may not entirely cover its respective automatic mechanism, in order to provide access to the automatic mechanisms behind the bottom covers. For example, bottom cover 160a may leave section 162a uncovered, in order to enable access to the automatic cover behind cover 160a. Similarly, sections 162b and 162c may be uncovered to enable access to their respective automatic mechanisms.

In some embodiments, access to the automatic mechanisms that are positioned at the top horizontal portion of the opening frame, may be achieved through the corresponding pane frame that each automatic mechanism is intended to operate. The access to each of the automatic mechanism may be from the bottom side of the top horizontal portion of the respective pane frame. Access to the automatic mechanism may be desired during assembly and maintenance. Easy and quick access to the automatic mechanism is enabled due to lack of cumbersome covers on the sides of the automatic mechanism, and further due to direct access through the bottom side of the upper horizontal portion of the pane frame.

Other numbers of sliding panes, and thus of respective bottom covers may be implemented. Typically, each sliding pane is parallel to another, thus each of their respective bottom covers is also parallel to one another.

In some embodiments, the shape of the bottom covers, e.g., bottom covers 160a, 160b, and 160c may be adjusted such to create a smooth continuation of the rest of the bottom side of the top horizontal end of opening frame 110. This is important both ecstatically as well as for operational reasons, such to ensure smooth sliding of each of the sliding panes that is to slidably move along the bottom side of the top horizontal portion of opening frame 110, e.g., along the guides of opening frame 110. For example, bottom covers 160a, 160b and 160c may be configured to form an extension of the guides that are a part of opening frame 110, and which are positioned on the bottom side of the top horizontal portion of opening frame 110, e.g., cover 160a may be shaped such to form an extension of guide 111. Similarly, cover 160b and cover 160c may be shaped as a continuation of guides 112 and 113, respectively.

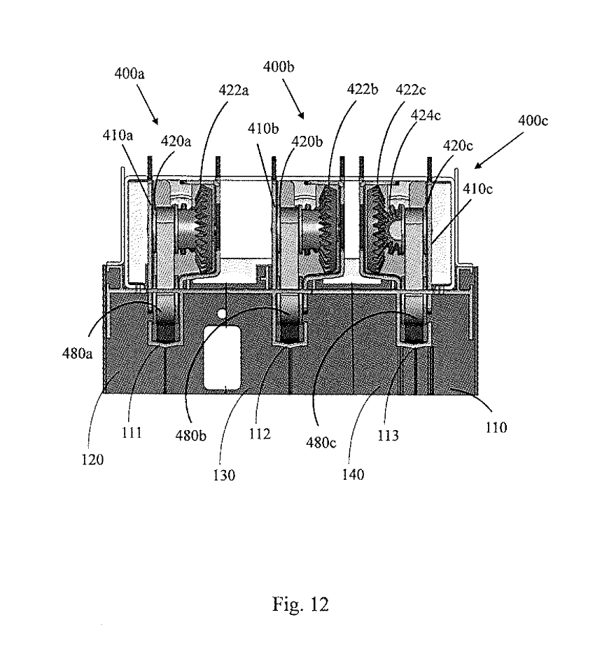

Reference is now made to FIG. 12, which is a schematic front-side cross-section of cogwheels and a toothed belts of a plurality of automatic mechanisms for operating sliding doors or windows, according to an embodiment of the disclosure. In the example illustrated in FIG. 12, three automatic mechanisms 400a, 400b and 400c may be located in close proximity to each other and in parallel to one another. Any other number of a plurality of automatic mechanisms that is to correspond to the number of sliding panes of a sliding door or window system, may be implemented. Typically, a plurality of sliding panes may be located in parallel to one another. One of the plurality of panes may be defined as the outer pane, for example, by the outer pane being located in front of all other sliding panes, closest to a user standing in front of the sliding door or window system, while another pane may be defined as the inner pane, e.g., by the inner pane being located at the back of all other sliding panes, farthest from a user standing in front of the sliding door or window system. Any additional pane may be located in between the outer sliding pane and the inner sliding panes.

In some embodiments, each of automatic mechanisms 400a, 400b and 400c may be intended to operate a single sliding pane. Each of automatic mechanisms 400a, 400b and 400c may comprise its own respective toothed belt that is used to pull the respective sliding pane to an open position or to a closed position. For example, automatic mechanism 400a may comprise toothed belt 480a, automatic mechanism 400b may comprise toothed belt 480b, and automatic mechanism 400c may comprise toothed belt 480c. Similarly, each of automatic mechanisms 400a, 400b and 400c may comprise its own respective bases, toothed pulleys and cog wheels. For example, automatic mechanism 400a comprises base 410a, toothed pulley 420a and cog wheel 422a, automatic mechanism 400b may comprise base 410b, toothed pulley 420b and cog wheel 422b, and automatic mechanism 400c may comprise base 410c, toothed pulley 420c and cog wheel 422c. Any other element that is essential to the operation of the automatic mechanisms, may be implemented similarly in each of automatic mechanisms 400a, 400b and 400c.

In some embodiments, the size of each automatic mechanism is no larger than the width of the pane frame surrounding the sliding pane that the automatic mechanism is to operate. This enables to position an endless number of automatic mechanisms to operate an endless number of typically parallel sliding panes.

As illustrated in FIG. 12, each of the automatic mechanisms may be positioned within the respective guides of the respective pane frame surrounding the sliding pane that each automatic mechanism is intended to operate. For example, automatic mechanism 400a may be positioned within guide 111 of pane frame 120, automatic mechanism 400b may be positioned within guide 112 of pane frame 130 and automatic mechanism 400c may be positioned within guide 113 of pane frame 140.

In some embodiments, each of the plurality of automatic mechanisms, e.g., automatic mechanisms 400a, 400b and 400c, may operate independently of any of the other automatic mechanisms, thus each sliding pane may open, close, partially open or partially close without being dependent on the position of any of the other sliding panes. For example, a user may operate the outer sliding pane to open while simultaneously operating the inner sliding pane to close. Each of the sliding panes may accomplish its respective instruction regardless of operation (or lack of operation) of any of the other sliding panes.

In other embodiments, the sliding panes' operation may be synchronized, such that automatic closing or opening of any one of the sliding panes may lead to the same operation of all other sliding panes. For example, if a user operates the outer sliding pane such that it is to slide to its closed position, the system may proceed to operate such that the rest of the sliding panes are also operated in order to complete closure of all sliding panes and thus perform a complete closure of the door or window system. And further in case the user operates the outer sliding pane to slide to its open position, all other sliding panes may be automatically and synchronously operated in order to reach their open position. According to this example, synchronous operation of all of the sliding panes may be initiated by operation of any one of the sliding panes. That is, operation of any one of the sliding panes may initiate operation of all other sliding panes at substantially the same time such to accomplish the same movement of either opening, closing, semi-opening or semi-closing the sliding door/window system.

In yet other embodiments, some sliding panes may be defined to move synchronously with other sliding panes, such that this group of predefined sliding panes may operate such to accomplish the same instruction of sliding to the same position (e.g., either an open position, a closed position, partially open position or partially closed position), while other sliding panes may be operated independently of the group of predefined synchronous sliding panes. For example, automatic mechanism 400a may be predefined to perform synchronized operation with automatic mechanism 400b, while automatic mechanism 400c may operate independently of operation of automatic mechanisms 400a and 400b. Thus, for example, if a user operates automatic mechanism 400a to perform a certain change in position (e.g., to open, close, partially open or partially close) the other synchronously connected automatic mechanism 400b will move synchronously with automatic mechanism 400a to perform the same change in position that is to be performed by automatic mechanism 400a. Similarly, if the user operates automatic mechanism 400b to perform a certain change in position (e.g., to open, close, partially open or partially close) its connected automatic mechanism 400a will move synchronously with automatic mechanism 400b to perform the same change in position that is to be performed by automatic mechanism 400b. While doing so, automatic mechanism 400c may not operate at all, or may operate to move to any position regardless of the instruction provided to and accomplished by the synchronized automatic mechanisms 400a and 400b. Any other combinations of any number of connected and/or independent automatic mechanisms may be implemented.

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment are necessary in every embodiment of the disclosure. Further combinations of the above features are also considered to be within the scope of some embodiments of the disclosure. It will also be appreciated by persons skilled in the art that the present disclosure is not limited to what has been particularly shown and described hereinabove.

We claim:

1. A system for operating sliding doors or windows, said system comprising:
an opening of a door or window comprising an opening frame and at least one sliding pane, said sliding pane comprising a pane frame; and
an automatic mechanism for operating said sliding pane comprising:
a motor positioned within a plane defined by the pane frame and corresponding to the sliding pane it is intended to move;
a first pulley connected to said motor via at least one cogwheel, said first pulley positioned along said plane defined by the pane frame;
a second pulley located adjacent to said first pulley and on the same plane as the first pulley;
a third pulley located adjacent to and on the same plane as said first pulley and said second pulley; and
a belt wound around said first pulley, said second pulley and said third pulley, wherein said belt is attached to a sliding pane of a door or window;
wherein said first pulley is configured to pull said sliding pane via the belt, and further wherein said second pulley and said third pulley are configured to thread at least a portion of the belt through the opening frame, said opening frame at least partially passing through the pane frame.

2. The system according to claim 1, wherein said first pulley is a toothed pulley.

3. The system according to claim 1, wherein said second pulley is a toothed pulley.

4. The system according to claim 1, wherein said third pulley is an idler pulley.

5. The system according to claim 1, wherein said belt is selected from a group consisting of: a belt, a chain, a cable, and a toothed timing belt.

6. The system according to claim 1, wherein said second pulley is located beneath said first pulley such that the axis of rotation of said second pulley is parallel to the axis of rotation of the first pulley, and further wherein said second pulley is displaced along an axis that is perpendicular to the axis of rotation of said first pulley.

7. The system according to claim 1, wherein said automatic mechanism is connected to a tension modulator configured to maintain an initial minimum tension of the belt.

8. The system according to claim 7, wherein the automatic mechanism and the tension modulator are situated on the plane defined by the pane frame, and corresponding to the sliding pane that the automatic mechanism is intended to operate.

9. The system according to claim 1, wherein said belt is configured to pass through a belt fastener, such that the belt is fastened towards and threaded through the opening frame.

10. The system according to claim 1, wherein said automatic mechanism is configured to fully or partially open, and fully or partially close the sliding pane of a door or window.

11. The system according to claim 1, wherein said system comprises a plurality of sliding panes, each sliding pane positioned in parallel to any other sliding pane, further wherein each sliding pane is associated with a corresponding automatic mechanism, each automatic mechanism positioned in parallel to any other automatic mechanism.

12. The system according to claim 11, wherein the width of each of the automatic mechanisms is no more than the width of a corresponding pane frame that surrounds the sliding pane associated with each of the automatic mechanisms.

13. The system according to claim 12, wherein each of said plurality of automatic mechanism operates independently of operation of any other automatic mechanism.

14. The system according to claim 12, wherein one of said plurality of automatic mechanisms performs any of the following operations: open, close, partially open, partially close or rest, while any other automatic mechanism simultaneously performs any of the following operations: open, close, partially open, partially close or rest.

15. The system according to claim 1, wherein each of said first, second and third pulleys rotates around a first, second and third shaft, respectively.

16. The system according to claim 15, wherein each of said first, second and third shafts is positioned on the plane defined by the pane frame.

17. The system according to claim 1, wherein the belt wounds around the first pulley, the second pulley, and the third pulley to create a U shaped loop in the belt, wherein the U shaped loop extends in the same plane as defined by the pane frame, in a direction away from the pane frame.

18. The system according to claim 1, wherein the width of the automatic mechanism is no more than the width of the pane frame.

19. The system according to claim 1, wherein access to the automatic mechanism is achieved through the bottom side of the top horizontal end of the pane frame.
